(19) United States
(12) Patent Application Publication
(10) Pub. No.: US 2008/0138586 A1
(43) Pub. Date: Jun. 12, 2008

(54) HYBRID STRUCTURE AND METHOD

(76) Inventors: Frank Robert Mooijman, Nieuwe Molenweg (NL); Prasad PS, Bangalore (IN); Poovanna TK, Bangalore (IN)

Correspondence Address: SABIC - 08CT;SABIC Innovative Plastics - IP Legal, ONE PLASTICS AVENUE, PITTSFIELD, MA, 01201-3697, US

(21) Appl. No.: 11/608,997

(22) Filed: Dec. 11, 2006

(51) Int. Cl. B32B 3/30; B29C 45/00; B32B 3/00

(52) U.S. Cl. 428/179; 428/174; 264/328.1

(57) ABSTRACT

Various hybrid structures and methods of making the hybrid structures are provided. In one embodiment, a hybrid structure includes a profile member and a continuous reinforcement member that are interlocked. The profile member includes a wall contiguous with at least two wall portions, or wall hems, which are at least partially separated from one another. The reinforcement member extends at least from the first wall hem to the second wall hem and contacts the first wall hem along a first surface of the wall and contacts the second wall hem along a second surface of the wall.

### FIELD OF THE INVENTION

The invention generally relates to a hybrid structure and method of making the hybrid structure. More particularly, the invention relates to a hybrid structure in which a profile member and reinforcement member are interlocked.

### BACKGROUND OF THE INVENTION

Hybrid structures that are made of a profile member and a reinforcement member, each of a different material, are used in the manufacture of high load-bearing applications, for example, automobiles components and machine frames. Hybrid structures can be made of an open or closed profile member that is often a metal profile member, and a reinforcement member, which is often a thermoplastic or thermosetting reinforcement member that are joined together.

There are different advantages of associated with hybrid structures of both closed and open profile members. For example, closed profile members that are typically made by hydro forming fixed diameter steel tubes, have excellent strength and torsion. Open profiles members, however, allow for design flexibility in varying the cross sections along the length of the profile members. There are several known methods of making hybrid structures using open profile members. For example, hybrid systems can be made by adhering a reinforcement member to a profile member using special adhesive systems that can bond two dissimilar materials without primer. In another method the reinforcement member is molded separately and then cold pressed to the profile member, such that, for example, a metal and a plastic member can be joined together in collar-joining operation to form a metal-plastic hybrids structure. Yet another method of joining the profile member and the reinforcement member of dissimilar materials, can be achieved via an injection molding process in which the molten polymer is injected between various opposing surfaces of the profile structure to produce reinforcement member, such as a rib structure which strengthens the open profile structure.

One challenge of open hybrid structures, however, is that despite the presence of a reinforcement member, they can have limited torsional and load carrying capability. Also, as the complexity in the design of the reinforcement member increases, the injection molding becomes more difficult due to flow restrictions, which require higher injection pressures and increased clamping force.

### SUMMARY OF THE INVENTION

The present invention provides for a hybrid structures having an interlock feature that provides for improved structural strength, rigidity, and torsion strength. The hybrid structure herein also provides for an improved method of fabrication.

In one embodiment, the hybrid structure includes a profile member and a continuous reinforcement member that are interlocked. The profile member includes a wall contiguous with at least two wall portions, or wall hems, which are at least partially separated from one another. The reinforcement member extends at least from the first wall hem to the second wall hem and contacts the first wall hem along a first surface of the wall and contacts the second wall hem along a second surface of the wall.

In another embodiment, the method for making the hybrid structure includes forcing a molten polymer into a profile member having a first wall hem and a second wall hem that are contiguous with a wall of the profile member and are at least partially separated from one another. In another embodiment the molten polymer contacts a first surface of the wall along the first wall hem and contacts a second surface of the wall, which is opposed to the first surface, along the second wall hem.

### BRIEF DESCRIPTION OF THE DRAWINGS

The various embodiments of the present invention can be understood with reference to the following drawings. The components are not necessarily to scale. Also, in the drawings, like reference numerals designate corresponding parts throughout the several views.

FIG. 1 is a perspective view of an open profile member which includes a wall contiguous with at least two discrete wall portions, according to an embodiment of the invention;

FIG. 2 is a perspective illustration of hybrid structure which includes the open profile of FIG. 1 further including a reinforcement member that extends through the at least two discrete wall portions, according to an embodiment of the invention;

FIG. 3 is a cross-sectional view taken along lines 3-3 of the hybrid structure of FIG. 2, according to an embodiment of the invention;

FIG. 4 is a perspective view of an alternative hybrid structure in which at least one wall hem is substantially planar, according to an embodiment of the present invention;

FIG. 5 is a cross-sectional view taken along lines 5-5 of the hybrid structure of FIG. 4, according to an embodiment of the invention;

FIG. 6 is a cross-sectional view taken along lines 5-5 of a hybrid structure of FIG. 5 showing the longitudinal cross section of the reinforcement member which extends between wall hems, according to an embodiment of the invention;

FIG. 7 is a cross-sectional view taken along lines 7-7 of FIG. 6 of the hybrid structure of FIGS. 4 through 6, according to an embodiment of the invention;

FIG. 8 is a perspective view of an alternative hybrid structure in which the wall hems protrude in the same direction, according to an embodiment of the invention;

FIG. 9 is a perspective view of an alternative hybrid structure having a reinforcement member which includes support ribs, according to an embodiment of the invention; and

FIG. 10 is a perspective view of an alternative hybrid structure in which the profile member includes a wall contiguous with at least three wall hems and a reinforcement member that extends through the wall hems along at least two axes, according to an embodiment of the invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

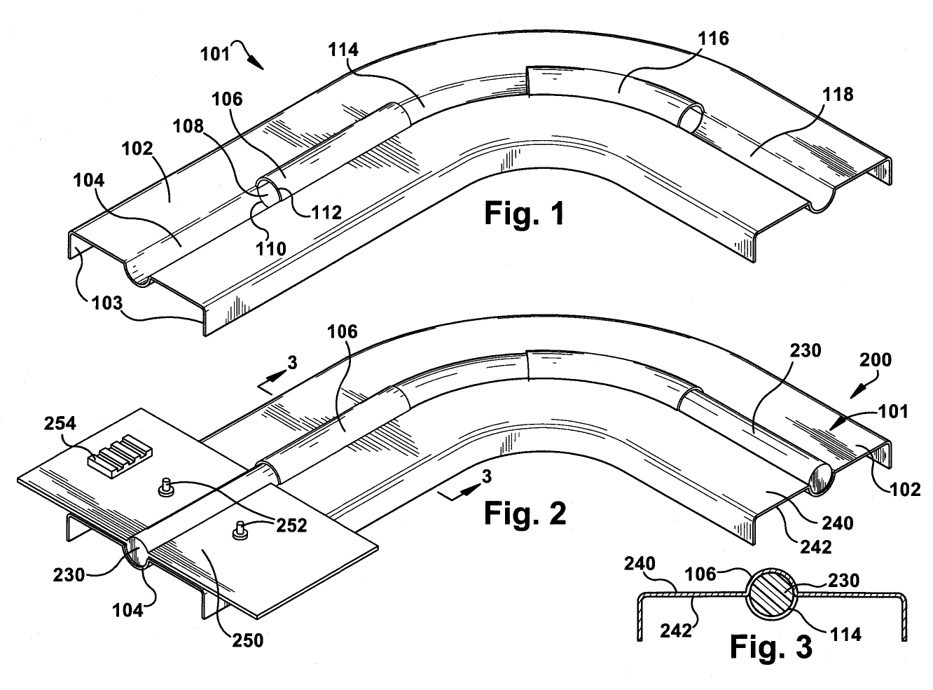

FIG. 1 is a perspective view of an open profile member 101 that can be used in a hybrid structure, according to an embodiment of the invention herein. Profile member 101 is shown in the shape of a U-channel having central wall 102 and sidewalls 103, however, one of many different profile configurations are possible. The open profile member wall 102 is contiguous with at least two wall portions, or “wall hems,” for example, adjacent wall hems 104 and 106. That is, wall 102 shares an edge or a boundary with wall hems 104 and 106 that are at least partially separated from one another. Wall 102 has an opening 108 that at least partially separates wall hem 104 and wall hem 106 along edge 110 and edge 112 of wall hems 104 and 106, respectively. A distance created by size of opening 108 separates the wall hems. Profile structure 100 includes a plurality of wall hems, for example, wall hems 114, 116 and 118, located along central wall 102 of profile member 100. The wall hems are arranged in series, adjacent to one another. The series of wall hems can be located along a single axis or along a curved section of the profile, or both as shown in FIG. 1.

The open profile structure 100 is shown curved, and can be shaped in a number of possible configurations. For example, resulting hybrid structures generally extend in several directions, for example, extending horizontally, upwards, or downwards, depending upon the selected routing pattern in an end use application.

FIG. 2 is a perspective illustration of hybrid structure 200 that includes the open profile member 101 of FIG. 1 and further includes reinforcement member 230. While the hybrid structure of FIG. 2 and the example embodiments of hybrid structures described below pertain to open channel hybrid structures, it should be understood that the present invention pertains to hybrid structures in general, and includes a reinforcement member that is attached to a profile member wherein the profile member may be open or closed. Also, profile member 101 may be metal and reinforcement member 230 may be thermoplastic to form a metal-plastic hybrid structure 200, however, alternative combinations of materials are for metal hybrids as will be further described.

In accordance with an embodiment of the invention, wall 102 of profile member 101 is contiguous with outwardly extending wall hems, for example, wall hems 114, 116. Each wall hem is at least partially separated from the other and forms a border that partially surrounds the reinforcing member 230. Reinforcement member 230 contacts the wall hems, for example wall hems 104 and 106, along top surface 240 and bottom surface 242 of wall 102, respectively, and is therefore locked to profile member 101. Reinforcement member 230 extends, at a minimum, at least partially along two wall hems, for example, along profile structure 101 while in contact with adjacent wall hems 104 and 106. Reinforcement member 230 can extend continuously along the length of profile member 101, such as along wall hems 114, 116, and 118, as shown, to form hybrid structure 200 and depends upon the selected design criteria of a particular end use application.

The reinforcement member 230 can be interlocked to the profile member by placing the profile member in a mold and filling the mold with molten polymer resin according to one of a variety of molding processes known to one of ordinary skill in the art and as will be further described. During the filling cycle, the molten polymer flows between the wall hems. For example, molten polymer can first contact the profile structure 101 at an end section, along wall hem 104 or wall hem 118, for example, and flow along a continuous path through several openings of wall 102 between the wall hems, toward the opposite end of the profile member. Solidification of the polymer creates a mechanical interlock between both the profile structure and reinforcement structure materials, producing a single unified component. Therefore, the present invention provides for continuous attachment or locking along the proximal portion, or origin as the main carrier of the melt, of reinforcement member 230 along at least a portion of the profile member, for example along its length. The size of the wall hems, for example the length or height, can vary for each wall hem, or they can be the same size as shown in FIG. 2. Additional locking may take place at discrete areas, or distal portions, of reinforcement member 230, for example, at pocket region 250 as will be further described.

The wall hems, for example wall hems 104 and 106, can facilitate the flow of molten polymer across the profile. For example, polymer can flow through opening 108 which separates wall hem 104 from wall hem 106, and through an opening (not shown) which separates wall hem 106 and wall hem 114, and so on, while alternatively contacting upper surface 240 and lower surface 242 of wall 102. Each wall hem can facilitate the injection molding process as a “flow leader” which encourages the front flow of polymer in a particular direction within the profile structure, for example a profile structure disposed within an injection mold during an injection molding process. A flow leader refers to the two opposing surfaces that define a cavity for the flow of molten polymer. Typically, a flow leader is the portion of the mold cavity having the greatest cross-sectional area compared to the other cavities within the mold. Therefore, in accordance with an embodiment of the present invention, wall hems, for example, wall hems 104, 106, disposed within a mold cavity, are the flow leaders that facilitate injection molding.

Hybrid structure 200 can also include at least one discrete pocket region 250 as mentioned above, which extends from proximal portion of reinforcement member 230. The pocket region 250 can be an extension of an open area of the proximal portion of the reinforcement member, opposite a wall hem, such as wall hem 104, or can extend through an opening of a wall hem (not shown), such as an opening through wall hem 106. Pocket region 250 provides a discrete thermoplastic structure for mounting additional accessories. Pocket region 250 can further include one or more molded-in thermoplastic features, such as, for example, pins 252 and rack 254, or alternative functional components for later connection to other components during fabrication of the end-use part, thereby eliminating labor and expense in the way of component assembly. The pocket region 250 may also be present to serve as a guide for assembly or a resting surface for other mechanisms, for example. In addition, pocket region 250 may be joined via integrated components to other pocket regions along hybrid structure 200 or to other hybrid structures.

FIG. 3 is a cross-sectional view taken along lines 3-3 of the hybrid structure of FIG. 2 showing that the reinforcement member 230 is substantially circular in shape being defined by convex wall hem 106 and concave wall hem 114. Wall hems, 104, 106, 114, 116 and 118 (FIG. 1) are alternatively concave and convex, and extend outwardly, in opposing directions, from planar portion of wall 102. Reinforcement member 230 also has open ends opposite the wall hems and between the wall hems.

The cross-sectional shape of the reinforcement member is substantially circular as shown in FIG. 3, however, the protrusions which define wall hems 106 and 114 can be a variety of shapes, such as, for example, rectangular, square, triangular, elliptical, polygonal, etc., and, alternative shapes are possible.

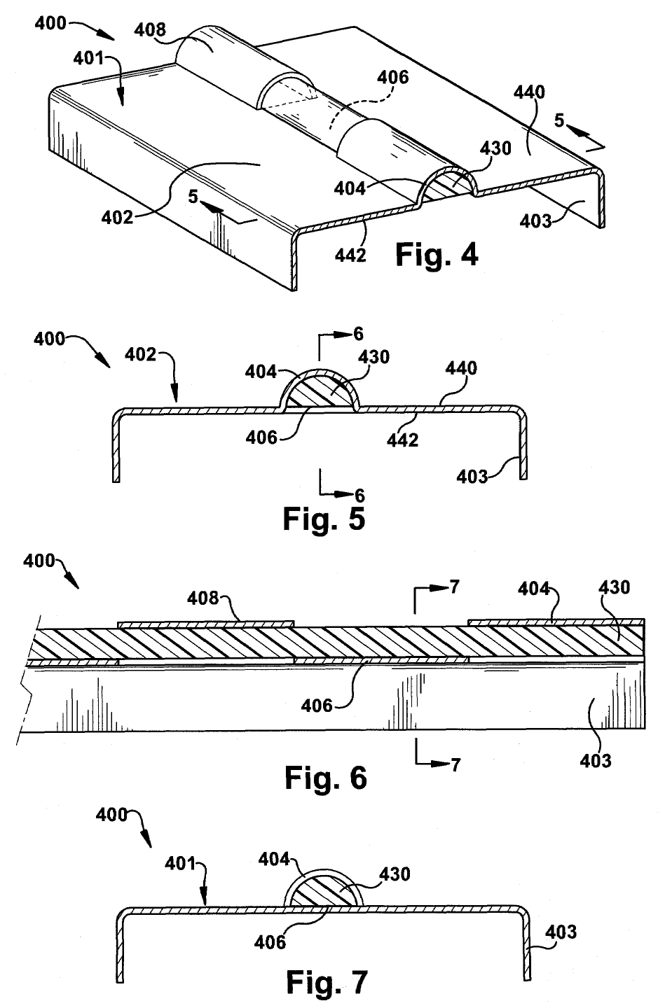

In an alternative embodiment, FIG. 4 shows a perspective view, and FIGS. 5 through 7 show cross-sectional views, of a hybrid structure 400 in which alternate wall hems protrude from the wall whereas intervening wall hems are substantially planar. Hybrid structure 400 includes a profile member that has wall 402 and sidewall 403 protruding therefrom, and wall 402 is contiguous with wall hems 404 and 406. Wall hems 404 and 408 are outwardly projecting, for example convex, and wall hem 406 is substantially planar and lies along the same plane with wall 402. FIG. 5 is a cross-sectional view of hybrid structure 400 taken along lines 5-5 of FIG. 4. Although hybrid structure 400, as shown, includes wall hems that are planar with intervening wall hems that protrude from wall 402 as outwardly projecting, for example wall hems 404 and 408 which protrude in a direction that is opposite to the projection of sidewall 403, hybrid structures with planar wall hems and intervening wall hems that protrude from wall 402 and are inwardly projecting, in a direction that coincides with the projection of sidewall 403 are also possible. FIG. 6 shows a longitudinal cross-sectional view of hybrid structure 400 taken along lines 6-6 of FIG. 5 showing reinforcement member 430 between wall hems, 404 and 406 and third wall hem 408 while contacting outer surface 440 (FIG. 4) and inner surface 442 (FIG. 4) of wall 402. A cross-section taken through planar hem 406 along lines 7-7 of FIG. 6 is shown in FIG. 7. Reinforcement member 430 is substantially semi-circular in shape and defined by outwardly extending, convex wall hems 404, 408 and substantially planar wall hem 406, although other cross-sectional shapes are possible as stated above.

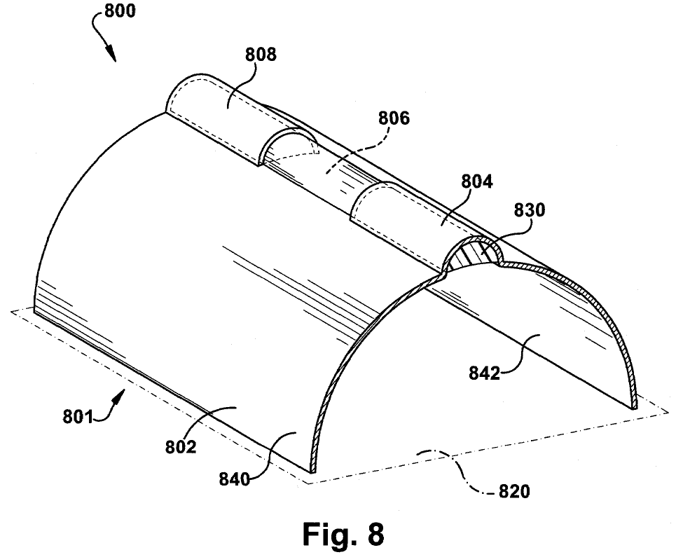

FIG. 8 is a perspective view of an alternative hybrid structure 800 that includes profile member 801 having a curved wall 802. In this embodiment, wall hems 804 and 806 (shown in phantom) protrude in the same direction, although in varying degrees. Wall hem 804 protrudes outwardly, beyond the curvature of wall 802, whereas wall hem 806 projects outward relative to a plane 820, for example, a plane which supports the hybrid structure 800. Reinforcement member 830 extends at least between two wall hems, for example, from wall hem 804 to wall hem 806 while contacting outer wall surface 840 and inner wall surface 842. Reinforcement member 830 can also extend through wall hem 808 and can extend the entire length of hybrid structure 800.

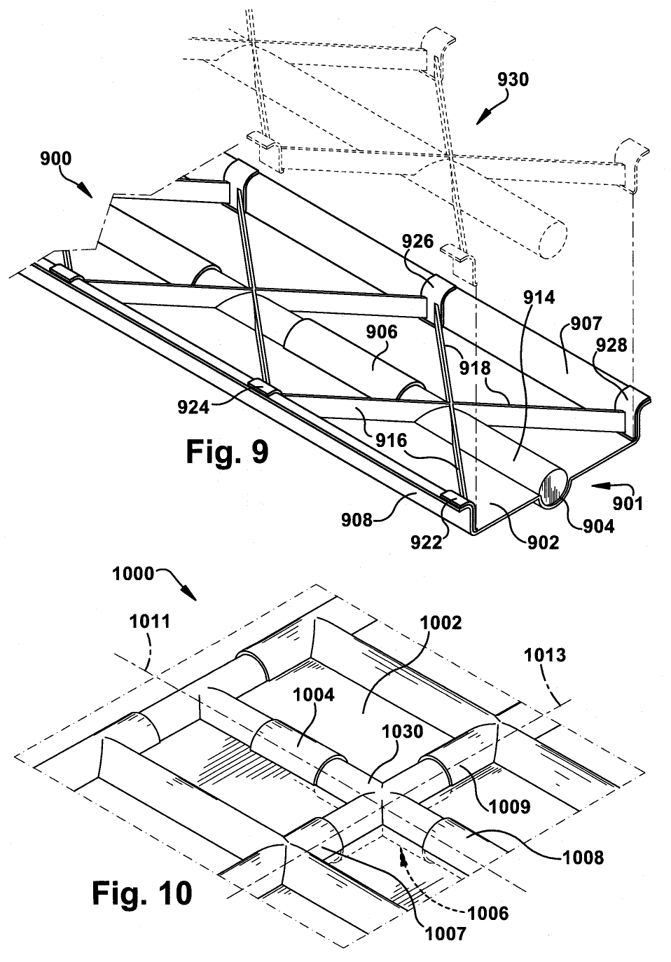

FIG. 9 is a perspective view of an alternative hybrid structure 900 which includes profile member 901 having planar wall 902 and sidewalls 907 and 930, and reinforcement member 930 (also shown in phantom). Reinforcement member 930 is interlocked with profile member 901 and contacts wall hems 904 and 906 that protrude from wall 902 in opposing directions. A plurality of support ribs, 916 and 918 provide intermediate connection between proximal portion 914 and distal portions 922, 924, 926 and 928 of reinforcement member 930 to reinforce and stiffen the hybrid structure 900. The plastic panel may include at least one, and in an alternative embodiment, a plurality of reinforcement members, or strengthening ribs. Profile member 901 can have a profiled edge (not shown) along sidewalls 907 and 908 so as to produce additional interlocking connection between the profile member 901 and the reinforcing member 930. As noted above, the length of the reinforcement member 930 need not traverse the full length of the profile member 901, and depends upon one or more of the filling pattern, the pressure requirement and/or the clamping force requirement that can be achieved. Therefore, the size and geometry of the part will also determine the length of the reinforcement member 930 and any reinforcing ribs or components.

FIG. 10 is a perspective view of an alternative hybrid structure 1000 in which the profile member includes a profile member 1001 having a wall 1002 contiguous with at least three wall hems 1004, 1006 (shown in phantom) and 1007, which are at least partially separated from one another. Wall hems 1004 and 1007 protrude from wall 1002 in a direction that is opposing the direction in which wall hem 1006 protrudes. Reinforcement member 1030 extends through the wall hems along two distinct axes, 1011 and 1013, and interlocked with profile structure 1001 in a two-dimensional matrix. The wall hems 1004 and 1007, and portions of reinforcement member 1030 which run through the wall hems, are shown oriented or separated by an angle of substantially 90° relative to one another, however, in alternative embodiments the wall hems and reinforcement members can be oriented in a plurality of directions and separated at various angles, for example, 180° or less relative to one another.

In any of the embodiments described above, materials that can be used for profile members and reinforcement members are different from one another and can vary. As mentioned above, the members can be made from metal or a reinforced plastic. The open-channel profile members can be made of several materials, which include, but are not limited to metal, such as steel, aluminum, magnesium; ceramics; and high strength plastic material, such as thermosetting materials or thermoplastic materials reinforced with long fibers, or other fillers and non-reinforced filled plastics or composites.

Examples of suitable non-reinforced, reinforced or filled plastics material that may be used as the thermoplastic material include, but are not limited to, a material based on polyamide (PA), polyester, such as, polyethylene terephthalate (PET), polybutylene terephthalate (PBT), polyolefin, such as, polypropylene (PP), polyethylene (PE), styrene-acrylonitrile copolymers, such as, acrylonitrile-styrene-butadiene copolymers (ABS), polycarbonate (PC), polypropylene oxide (PPO), (PSO), polyphenylene sulfide (PPS), polyimide (PI), (PEE), polyketone, syndiotactic polystyrene (PS) and mixtures of these polymeric materials.

The resulting hybrid structure described herein, have high strength, and excellent strength to weight ratio when thermoplastics are used. Applications for the use of hybrid structures include, but are not limited to, a member for machinery, vehicles, washing machine frames, chassis or housing or electronic machines, for example, computer PCB holders, mobile phone structures, laptop structures, chassis of document handling equipments, such as printers, photo copy machines, scanners, body panels of bikes, farm equipments, instrument panels, rails, office furniture and medical equipment. Large hybrid structures for use in motor vehicle components, for example a structure that is used in the front end of an automobile may be well over 1 meter in a along an axis and can include from around 3 to 10 kilograms of thermoplastic material.

The open profile members can be made from a non-reinforced polymer, a reinforced polymer, a stamped metal or a stamped reinforced polymer, for example, a polymer impregnated with long-glass fiber that is stamped in a press to form a thermoplastic or thermoset open, profile member. Metal sheet may be stamped in a press for simple shapes, additional tools such as a piercing tool, a blanking tool, a forming tool, bending tools can be used to achieve a finer shape of the hybrid structure depending on the complexity of the metal stamping.

The hybrid structure herein including but not limited to the hybrid structures described above can be made, according to one embodiment, by forcing a molten polymer into a profile member having a first wall hem and a second wall hem which are contiguous with a wall of the profile member and the wall hems are at least partially separated from one another. In another embodiment the molten polymer contacts a first surface of the wall along the first wall hem and contacts a second surface of the wall, which is opposed to the first surface, along the second wall hem. When the polymer solidifies a mechanical interlock is created between the profile member and the reinforcing member producing a unified component.

In anther embodiment the method of producing a hybrid structure herein, further includes separating a portions of the wall of a profile member before forcing molten polymer into the profile. With reference to FIG. 1, the method includes partially separating a portion of wall 102 of profile structure 100. A portion of wall 102 is shown separated along wall edges 110 and 112 that create a discontinuity in wall 102 and allows for the formation of two adjacent wall hems, for example wall hems 104 and 106. A plurality of separations can be made in wall 102 to allow for the formation of a plurality of wall hems, for example 104, 106, 114, 116 and 118. For example, the at least one separation in profile member 102 can be made by cutting, lancing or piercing perforations into the profile member.

Once a separation is made, the method further includes forming the wall hems by applying a force to the wall 102 adjacent to at least one of the wall edges 110, 112, for example. That is pressure can be applied to the portion of wall 102 that becomes wall hem 104, or to the portion of wall 102 that becomes wall hem 106, or pressure can be applied to both portions. For example, the pressure can be applied to form an opening 110 between wall edges 110 and 1 12. For example, the method can include pressing the wall of the member so as to achieve concave wall hems 104, 114, 118, and convex wall hems 106, 116. As these alternatively concave and convex wall hems are formed, the wall edges 110, 112, of the structural member becomes moved in opposing directions, thereby creating openings 1 10. The size of the openings 110 can be varied depending upon the size of the part and the selected thickness of reinforcement member, for example, reinforcement member 230 (FIG. 2). Depending upon the application requirements, the hole or slot sizes will be determined. For example, a thicker runner will be used for large parts and where the flow length across the part is greater. Typically, the runners are the thickest sections of the part, however sometimes local sections can have thicknesses that are greater than runners due to functional requirements at closed locations.

In the method described above, at least one separation of wall 102 is made, via for example, cutting, lancing shearing, piercing, etc., prior to forming the wall portions that become wall hems 104 and 106. However, in an alternative embodiment, separations in wall 102 can be made simultaneous to forming the wall hems of profile member 100. For example, pressure applied, for example in the way of punches to the profile member 100, can cause wall 102 to be sheared thereby forming an opening, for example opening 110, if a minimum clearance or distance exists between punches.

Therefore, in one embodiment of the present invention, the method for making a hybrid structure includes forcing polymer resin into a profile structure having a first wall hem and a second wall hem that are contiguous with a wall of the profile member, and the wall hems being at least partially separated from one another. In another embodiment the polymer contacts a first surface of the wall along the first wall hem and contacts a second surface of the wall, which is opposed to the first surface, along the second wall hem. In yet another embodiment of the invention the method for making the hybrid structure includes the steps of separating at least a portion of the wall of a profile structure; forming wall hems, and forcing polymer resin along a first surface and a second surface of a wall of the profile member according to a known polymer processes. The separating and forming steps can be done simultaneously or sequentially. Polymer may be forced into a wall hem or an opening between two wall hems. For example the profile member can be placed into a mold and the polymer may enter the mold, for example, via a nozzle, which is aligned with a wall hem or a series of wall hems. The wall hems can therefore become the flow leader and main carrier of the melt through the part. Solidification of the plastic creates a mechanical interlock between both the materials, producing a single unified component.

While injection molding is a suitable method of placing or forcing resin into profile member to a form hybrid structure, it can be appreciated that other suitable forming methods are available and may be used within the scope of the present invention. These methods include, but are not limited to, compression molding, injection compression molding, extrusion, compress, gas assist or water assist pressure molding, low pressure molding, blow molding, thermoforming and rotational molding.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A hybrid structure comprising:
a profile member comprising a wall contiguous with a first wall hem and a second wall hem, wherein the first wall hem and the second wall hem are at least partially separated from one another; and
a reinforcement member which contacts a first surface of the wall along the first wall hem and continuously extends to a second surface of the wall along the second wall hem.

2. The hybrid structure of claim 1, wherein at least one of the first wall hem and the second wall hem protrudes from the wall and at least one of the first wall hem and the second wall hem is substantially planar.

3. The hybrid structure of claim 1, wherein at least one of the first wall hem and the second wall hem wall hem protrudes in a first direction, and at least one of the first wall hem and the second wall hem protrude in a second direction that is opposite the first direction.

4. The hybrid structure of claim 3, wherein at least one of the first wall hem and the second wall hem is concave, and at least one of the first wall hem and the second wall hem is convex.

5. The hybrid structure of claim 1, wherein the first wall hem and the second wall hem protrude in the same direction.

6. The hybrid structure of claim 1, wherein the reinforcement member contacts the first surface of wall along a convex protrusion of the wall, and the reinforcement member contacts the second surface of the wall along a concave protrusion of the wall.

7. The hybrid structure of claim 1, wherein the first wall hem and the second wall hem are adjacent to one another.

8. The hybrid structure of claim 1, wherein the first wall hem and the second wall hem are oriented at an angle relative to one another.

9. The hybrid structure of claim 1, wherein the hybrid structure further comprises a third wall hem that is in series with the first and the second wall hem.

10. The hybrid structure of claim 1, wherein the hybrid structure further comprises a third wall hem and the third wall hem is oriented at an angle relative to at least one of the first and the second hem.

11. The metal hybrid structure of claim 1, wherein the wall hems are the flow leader of the hybrid structure.

12. The hybrid structure of claim 1, wherein the proximal portion of the reinforcement member is in contact with the first wall hem and the second wall hem.

13. The hybrid structure of claim 1, wherein the reinforcing member comprises reinforcement ribs.

14. The hybrid structure of claim 1, wherein the reinforcing member further comprises pocket regions.

15. The hybrid structure of claim 14, wherein the pocket region further comprises at least one molded-in feature.

16. The hybrid structure of claim 1, wherein the reinforcement member comprises a thermoplastic material selected from at least one of: polyamide, polyester, polyolefin, polyethylene, styrene-acrylonitrile copolymers, acrylonitrile-styrene-butadiene copolymers, polycarbonate, polypropylene oxide, polyphenylene sulfide, polyimide, polyketone, syndiotactic polystyrene, and mixtures thereof.

17. The hybrid structure of claim 1, wherein the profile member comprises a material selected from polymer, metal, ceramic, and mixtures thereof.

18. The hybrid structure of claim 1, wherein the reinforcement member comprises polymer and the profile member comprises metal.

19. A method of making a hybrid structure comprising:
forcing polymer into a profile member;
wherein the profile member comprises a wall and a first wall hem and a second wall hem which are contiguous with the wall and the first wall hem and the second wall hem are at least partially separated from one another.

20. The method of claim 19, wherein the wall of the profile member has a first surface and an opposing second surface, and the polymer that is forced into the profile member contacts the first wall surface along the first wall hem and contacts the second surface along the second wall hem.

21. The method of claim 20, further comprising:
separating at least a portion of the wall of the profile member to create the first wall hem and the second wall hem before forcing the polymer into the profile member.

22. The method of claim 21, further comprising:
forming the first wall hem and the second wall hem after separating a portion of the wall and before forcing the polymer into the profile member.

23. The method of claim 21, further comprising:
forming the first wall hem and the second wall hem while separating a portion of the wall of the profile member.

24. The method of claim 19, wherein the polymer is forced into the profile member by a process selected from injection molding, compression molding, injection compression molding, extrusion, compress, gas assist or water assist pressure molding, low pressure molding, blow molding, thermoforming and rotational molding.

25. The method of claim 19, wherein the polymer is forced into the profile member by injection molding.
